(19) United States
(12) Patent Application Publication
(10) Pub. No.: US 2021/0258646 A1
(43) Pub. Date: Aug. 19, 2021

(54) Set-Top Box Configured for Receiving and Using Wireless Broadband Television Broadcasts and Cable Television Broadcasts and Associated System and Process

(71) Applicant: TracFone Wireless., Inc., Miami, FL (US)

(72) Inventor: Theodore Vagelos, Miami, FL (US)

(21) Appl. No.: 17/176,570

(22) Filed: Feb. 16, 2021

Related U.S. Application Data
(60) Provisional application No. 62/976,628, filed on Feb. 14, 2020.

(51) Int. Cl. H04N 21/462; H04N 21/431; H04N 21/433; H04N 21/472; H04N 21/482

(52) U.S. Cl. CPC H04N 21/4622; H04N 21/4314; H04N 21/4828; H04N 21/47217; H04N 21/4333

(57) ABSTRACT

A wireless broadband television system is disclosed. The wireless broadband television system includes a set-top box. The set-top box includes a wireless broadband television transceiver configured to receive television services as broadband data from a wireless network; a processor configured to control the wireless broadband television transceiver and execute an application; and an output configured to output audio and video associated with received television services.

### CROSS-REFERENCE TO RELATED APPLICATIONS

This application claims the benefit from U.S. Provisional Application No. 62/976,628 filed on Feb. 14, 2020, which is hereby incorporated by reference in its entirety for all purposes as if fully set forth herein.

### BACKGROUND OF THE DISCLOSURE

### 1. Field of the Disclosure

The disclosure relates to a set-top box for receiving and using wireless broadband television broadcasts and cable television broadcasts. The disclosure further relates to a process for implementing a set-top box for receiving and using wireless broadband television broadcasts and cable television broadcasts.

The disclosure further relates to a system for providing and supporting wireless broadband television broadcasts. The disclosure further relates to a process for providing and supporting wireless broadband television broadcasts.

### 2. Related Art

Currently, cable television companies pay local broadcasters for re-transmission of their signal and/or content over cable and add the cost to a customer's monthly cable fees. Customers are dropping cable and satellite programming packages due to the increased monthly cable fees. However, this results in customers losing local broadcast content as well as other cable and satellite programming.

Accordingly, a need exists to provide a set-top box for receiving and using television broadcasts utilizing different functionality as well as receiving cable television broadcasts. Moreover, a need exists for a system for providing television broadcasts utilizing different functionality as well as cable television broadcasts.

### SUMMARY OF THE DISCLOSURE

The foregoing needs are met, to a great extent by the disclosure, by providing a set-top box for enabling wireless broadband television broadcast and cable television reception and usage as well as a process for implementing a set-top box for enabling wireless broadband television broadcast and cable television reception and usage. The foregoing needs are further met, to a great extent by the disclosure, by providing a system for enabling and supporting wireless broadband television broadcast and cable television transmission as well as a process for implementing a system for enabling and supporting wireless broadband television broadcast and cable television transmission.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will also form the subject matter of the claims appended hereto.

One aspect includes a wireless broadband television system that includes: a set-top box and the set-top box that includes: a wireless broadband television transceiver configured to receive television services as broadband data from a wireless network; a processor configured to control the wireless broadband television transceiver and execute an application; the application configured to connect utilizing the wireless broadband television transceiver to the wireless network; the application is further configured to implement and control the wireless broadband television transceiver; an output configured to output audio and video associated with received television services; and a computer readable medium configured to store the application.

One aspect includes a wireless broadband television system process that includes: providing a set-top box; configuring the set-top box with a wireless broadband television transceiver to receive television services as broadband data from a wireless network; configuring the set-top box with a processor to control the wireless broadband television transceiver and execute an application; configuring the application to connect utilizing the wireless broadband television transceiver to the wireless network; configuring the application to implement and control the wireless broadband television transceiver; configuring the set-top box with an output to output audio and video associated with received television services; and configuring the set-top box with a computer readable medium to store the application.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

The above-mentioned features and aspects of the disclosure will become more apparent with reference to the following description taken in conjunction with the accompanying drawings wherein like reference numerals denote like elements and in which:

FIG. 1 illustrates an exemplary set-top box having a wireless broadband receiver in accordance with aspects of the disclosure.

FIG. 2 illustrates another exemplary set-top box and a separate wireless broadband television transceiver in accordance with aspects of the disclosure.

FIG. 3 illustrates a wireless broadband receiver in accordance with aspects of the disclosure.

FIG. 4 illustrates an exemplary television broadcast network and wireless network as well as set-top boxes in accordance with aspects of the disclosure.

FIG. 5 illustrates a wireless broadband television broadcast support platform in accordance with aspects of the disclosure.

FIG. 6 illustrates a graphical user interface for a set-top box in accordance with aspects of the disclosure.

FIG. 7 illustrates a process of implementing a wireless broadband television broadcast support platform and/or an application responsive to a wireless broadband television broadcast support platform in accordance with aspects of the disclosure.

FIG. 8 illustrates a remote control in accordance with aspects of the disclosure.

### DETAILED DESCRIPTION

The disclosure relates to implementing a set-top box that utilizes a wireless broadband receiver to receive local broadcast content. In additional aspects of the disclosure, the set-top box may include implementations for connecting to a platform and may include a native subscription management software application along with a remote policy management system, such as server, that may enable free local high definition television broadcasts and programming and/or paid local high definition television broadcasts and programming. Additionally, the disclosure may provide a set-top box that provides a platform that may support HD Television Broadcast enablement, access to programming, and subscription management, and the like.

The disclosure further relates to implementing a system that utilizes a wireless broadband transmitter to transmit local broadcast content. In additional aspects of the disclosure, the system may include implementations for a platform and may include a native subscription management software application along with a remote policy management system, such as server, that may enable free local high definition television broadcasts and programming and/or paid local high definition television broadcasts and programming. Additionally, the platform may support HD Television Broadcast enablement, access to programming, and subscription management, and the like.

The disclosure may include a software application that may enforce platform server polices in real time based upon subscription rules and subscriber status. In certain aspects, the software application may manage the set-top box operation, channel access and display, and the like.

Set-top boxes may connect to a “wireless network” or “network” and are intended to encompass any type of wireless network to obtain or provide wireless broadband television services through the use of a set-top box, such as a Global System for Mobile Communication (GSM) network, a Code-Division Multiple Access (CDMA) network, a Long-Term Evolution (LTE) network, a 4G network, a 5G network, a Wi-Fi network, a network implementing a communication channel as defined herein, and the like that may utilize the teachings of the disclosure.

Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described, which may be requirements for some aspects but not for other aspects.

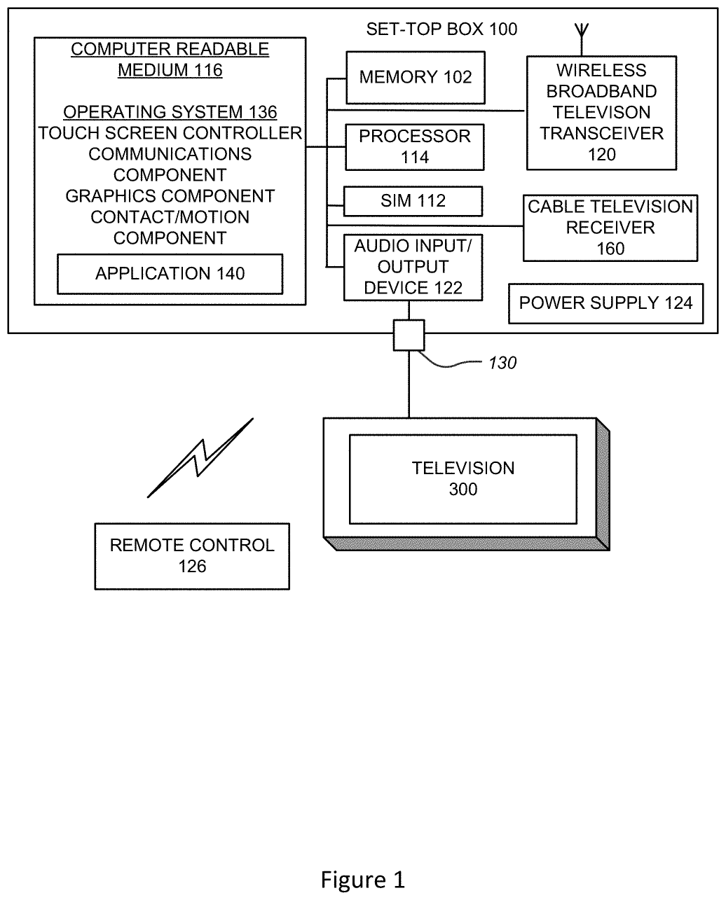

FIG. 1 illustrates an exemplary set-top box having a wireless broadband receiver in accordance with aspects of the disclosure.

In particular, FIG. 1 illustrates an exemplary implementation of the set-top box 100. The set-top box 100 may include one or more of a wireless broadband television transceiver 120, a computer readable medium 116, a processor 114, an application 140, a power supply 124, a cable television receiver 160, a memory 102, a SIM 112, an audio input/output device 122, a location determination device, and the like. However, the set-top box 100 may be implemented with a greater number of components or a fewer number of components depending on the desired implementation and the desired features for the set-top box. The set-top box 100 may be responsive to a remote control 126.

FIG. 1 further illustrates that the set-top box may include a wireless broadband television transceiver 120. In one aspect, the wireless broadband television transceiver 120 may be configured to connect to a “wireless network” or “network” to obtain wireless broadband television services. In one aspect, the wireless broadband television transceiver 120 may be configured to connect to a “wireless network” or “network” to obtain wireless broadband television services received by broadband data, mobile broadband data, broadband wireless data, and/or the like. In this regard, a “wireless network” or “network” includes a Global System for Mobile Communication (GSM) network, a Code-Division Multiple Access (CDMA) network, a Long-Term Evolution (LTE) network, a 4G network, a 5G network, a Wi-Fi network, a network implementing a communication channel as defined herein, and the like that may utilize the teachings of the disclosure.

The wireless broadband television transceiver 120 can include, for example, a wireless antenna and associated circuitry capable of data transmission with a mobile data network utilizing at least one data transmission protocol utilizing one or more communication channels as defined herein. The wireless broadband television transceiver 120 may transmit and receive data utilizing the data transmission protocol. In one aspect, the processor 114 and/or the wireless broadband television transceiver 120 may be implemented as a chipset. In one aspect, the processor 114, the wireless broadband television transceiver 120, and/or the wireless broadband television transceiver 120 may be implemented as a chipset.

In one aspect, the wireless broadband television transceiver 120 may be configured to support technologies, including High Efficiency Video Coding (HEVC) for video channels of up to 2160p 4K resolution (horizontal display resolution of approximately 4,000 pixels) at 120 frames per second, wide color gamut, high dynamic range, Dolby AC-4 and MPEG-H 3D (Moving Picture Experts Group) Audio, datacasting capabilities, and robust wireless broadband television support. In further aspects, the wireless broadband television transceiver 120 may utilize different video coding with a different resolution. In further aspects, the wireless broadband television transceiver 120 may utilize different video coding with a higher resolution. In one aspect, the wireless broadband television transceiver 120 may implement ATSC 3.0 (Advanced Television Systems Committee) standards.

In one aspect, the wireless broadband television transceiver 120 may implement other digital television broadcast standards including DVB standards, DVB-T, DVB-T2, DVB-S, DVB-S2, DVB-S2X, DVB-C, DVB-C2, DVB-H, DVB-NGH, DVB-T2-Lite, DVB-SH, ATSC 2.0, ATSC-M/H, ISDB, ISDB-T, ISDB-T, SBTVD, ISDB-S, ISDB-C, 1seg, DTMB, DTMB, DTMB-A, CMMB, DMB standard, T-DMB, S-DMB, and the like. In one aspect, the wireless broadband television transceiver 120 may utilize various Codecs including H.265/MPEG-H HEVC, H.264/MPEG-4 AVC, H.262/MPEG-2 Part 2, VC-1, AVS, MPEG-H, HE-AAC, AAC, AC-4, E-AC-3, AC-3, MP3, MP2, the like. In one aspect, the wireless broadband television transceiver 120 may be implemented to receive various frequency bands including VHF (Very High Frequency), UHF (Ultra High Frequency), SHF (Super High Frequency), and the like.

The cable television receiver 160 may be configured to receive television programming via radio frequency (RF) signals transmitted through coaxial cables or in light pulses through fiber-optic cables from a cable television network. The cable television receiver 160 may be implemented with one or more digital cable Quadrature amplitude modulation (QAM) tuners. The cable television receiver 160 may be configured to receive television programming via radio frequency (RF) signals transmitted from a satellite. The cable television receiver 160 may be implemented with one or more digital cable Quadrature amplitude modulation (QAM) tuners. In particular, although the disclosure references cable television provided from a cable television network, the various features described herein are equally applicable to satellite television broadcasts provided from a satellite television network.

The audio input/output device 122 may implement a HDMI (High-Definition Multimedia Interface) output utilizing a HDMI connector 130. The audio input/output device 122 implementing the HDMI output may implement an audio/video interface for transmitting uncompressed video data and compressed or uncompressed digital audio data from the set-top box 100 to an HDMI-compliant device, such as a display, a controller, a compatible computer monitor, a video projector, a digital television 300, a digital audio device, and/or the like. As illustrated in FIG. 1, the audio input/output device 122 implementing the HDMI output may implement an audio/video interface for transmitting uncompressed video data and compressed or uncompressed digital audio data from the set-top box 100 to the digital television 300 via the HDMI connector 130. Other types of video and/or audio input connections and output connections are contemplated as well.

The processor 114 of the set-top box 100 may be configured to execute the application 140. In one aspect, the application 140 may be a wireless broadband television reception application. The processor 114 can be, for example, dedicated hardware as defined herein, a computing device as defined herein, a processor, a set-top box processor, a microprocessor, a set-top box chipset, a central processing unit (CPU), a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute the application 140.

The application 140 may be written in any programming language, such as, for example, C, Java, Objective-C, C+, Python, Visual Basic, Perl, or any other programming language the processor 114 is capable of executing. The application 140 may be downloaded by the set-top box 100, may be stored on a chipset, the SIM 112 of the set-top box 100, stored in the memory 102, stored in the computer readable medium 116, may be part of the system bios of the set-top box 100, or the like.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide subscription management features. In one aspect, the wireless broadband television services as described by this disclosure may include subscription to various information, features, data, and the like provided by the application 140 and/or the wireless broadband television broadcast support platform 260. In one aspect, the application 140 may be configured to add, modify, or the like subscription to the various information, features, data, and the like provided by the application 140 and/or the wireless broadband television broadcast support platform 260. In one aspect, the application 140 may be configured to generate a graphical user interface on a display device such as the digital television 300 to display controls to view, utilize, implement, add, delete, modify, and/or the like subscription to the various information, features, data, and the like provided by the application 140 and/or the wireless broadband television broadcast support platform 260. In one aspect, the subscription management software application may be implemented as a native application. In one aspect, the subscription management may include management of DVR functionality, programming information, television guide information, channel access and display information, polices, subscription rules, and subscriber status, and the like. In one aspect, the subscription management may be management of any services and information described herein. In this regard, the remote control 126 may interact with the set-top box 100 and/or the application 140 to provide input and control of the features described above.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide access to programming information on a display device such as the digital television 300. In one aspect, the programming information may be provided by the application 140 and/or the wireless broadband television broadcast support platform 260. In one aspect, the application 140 may be configured to view, utilize, implement, add, delete, modify, and/or the like programming information provided by the application 140 and/or the wireless broadband television broadcast support platform 260. In one aspect, the application 140 may be configured to generate a graphical user interface to display controls to view, utilize, implement, add, delete, modify, and/or the like the programming information provided by the application 140 and/or the wireless broadband television broadcast support platform 260. In this regard, the remote control 126 may interact with the set-top box 100 and/or the application 140 to provide input and control of the features described above.

In one aspect, the programming information may include Electronic program guides (EPGs) and/or interactive program guides (IPGs) that may be menu-based systems that provide users of the application 140 with continuously updated menus displaying broadcast programming (TV listings) or scheduling information for current and upcoming programming on a display device such as the digital television 300. In some aspects, the application 140 may include guides that may also feature backward scrolling to promote catch up content. In this regard, the remote control 126 may interact with the set-top box 100 and/or the application 140 to provide input and control of the features described above.

In one aspect, the programming information may include non-interactive electronic program guides and may include a digitally displayed, non-interactive menu of program scheduling information shown by a television provider to its viewers on a display device such as the digital television 300. In one aspect, the programming information may allow users to navigate scheduling information menus interactively, selecting and discovering programming by time, title, channel or genre using an input of the set-top box 100. In one aspect, the programming information may include data used to populate an interactive EPG that may be distributed over the wireless network 200, the Internet, and/or the like from the wireless broadband television broadcast support platform 260, either for a charge or free of charge, and implemented on the set-top box 100 utilizing the application 140. In this regard, the remote control 126 may interact with the set-top box 100 and/or the application 140 to navigate, provide input, and control of the features described above.

In one aspect, the application 140 may be configured with the set-top box 100 and/or the wireless broadband television transceiver 120 to implement the application 140 and/or the application 140 may be configured to be responsive to a wireless broadband television broadcast support platform 260 to enforce the wireless broadband television broadcast support platform 260 polices in real time based upon subscription rules and subscriber status. In one aspect, the policies may be enforced by the application 140 that are provided by the wireless broadband television broadcast support platform 260. In one aspect, the wireless broadband television broadcast support platform 260 may be configured to view, utilize, implement, add, delete, modify, and/or the like policies based upon subscription rules and subscriber status. In some aspects, the subscription may be a paid service. In some aspects, the subscription may provide any services and information described herein.

In one aspect, the application 140 may be configured with the set-top box 100 and/or the wireless broadband television transceiver 120 to implement the application 140 and/or the application 140 may be configured to be responsive to a wireless broadband television broadcast support platform 260 to manage the wireless broadband television transceiver 120, channel access and display, and the like. In one aspect, the application 140 may be configured to view, utilize, implement, add, delete, modify, and/or the like channel access provided by the application 140 and/or the wireless broadband television broadcast support platform 260 on a display device such as the digital television 300. In one aspect, the application 140 may be configured to generate a graphical user interface to display television programming provided by the application 140 and/or the wireless broadband television broadcast support platform 260. In one aspect, the application 140 may be configured to generate a graphical user interface to display television programming provided by the application 140 and/or the wireless broadband television broadcast support platform 260 based on a location of the set-top box 100. In this regard, the remote control 126 may interact with the set-top box 100 and/or the application 140 to provide input and control of the features described above.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide television scheduling on a display device such as the digital television 300. In one aspect, the television scheduling may include channels, television shows, sporting events, times, length of shows, cast, production crew and personnel biographies, plot summaries, trivia, fan reviews and ratings, and the like. In this regard, the remote control 126 may interact with the set-top box 100 and/or the application 140 to provide input and control of the features described above.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide television guide information on a display device such as the digital television 300. In one aspect, the television guide information may be provided by paid subscription. The television guide information may include channels, television shows, sporting events, times, length of shows, cast, production crew and personnel biographies, plot summaries, trivia, fan reviews and ratings, and/or the like. In one aspect, the application 140 may include a graphical user interface to search the television guide to find television content. In one aspect, the application 140 may include a graphical user interface to search the television guide to find television content along with the ability to designate particular television content as a favorite for future viewing, quick access, generation of reminders, generation of calendar events, and the like. Interaction with the graphical user interface may be through the remote control 126.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide digital video recorder (DVR) functionality. In one aspect, the application 140 may provide an on-screen guide of scheduled broadcast programming television programs on a display device such as the digital television 300. In one aspect, the application 140 may be configured to receive instructions from a user to record every episode of a series. In one aspect, the application 140 may support searches, which allow the user to find and record shows that match their interests by title, actor, director, category, or keyword. In one aspect, digital video recorder (DVR) functionality may be implemented by the application 140 and may operate the wireless broadband television transceiver 120 to receive particular television programming and store the particular television programming in the memory 102 in a digital format. The instructions and control may be provided by the remote control 126.

In one aspect, the digital video recorder (DVR) functionality may include the ability to select and play back the particular television programming stored in the memory 102 on a display device such as the digital television 300. In one aspect, digital video recorder (DVR) functionality may include the ability to delete the particular television programming stored in the memory 102. In one aspect, digital video recorder (DVR) functionality may include the ability to automatically store television programming stored in the memory 102 based on a user's prior recording history, interests, and the like. In one aspect, the digital video recorder (DVR) functionality may include the ability to automatically record and store television programming in the memory 102 based on artificial intelligence utilizing a user's prior recording history, interests, and the like. In this regard, the remote control 126 may interact with the set-top box 100 and/or the application 140 to provide input and control of the features described above.

In one aspect, digital video recorder (DVR) functionality may include the ability to skip commercials based on information in the received television signals. In one aspect, this functionality may be provided through a paid service implemented by the wireless broadband television broadcast support platform 260. In one aspect, the digital video recorder (DVR) functionality may include the ability to prevent the recording of commercials based on information in the received television signals. In one aspect, this functionality may be provided through a paid service implemented by the wireless broadband television broadcast support platform 260. In one aspect, digital video recorder (DVR) functionality may include the ability to record, pause, fast-forward, rewind, and the like the received television signals on a display device such as the digital television 300. In this regard, the remote control 126 may interact with the set-top box 100 and/or the application 140 to provide input and control of the features described above.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide the digital video recorder (DVR) functionality utilizing voice recognition. In one aspect, digital video recorder (DVR) functionality may include the ability to record particular television programming stored in the memory 102 based on instructions obtained through voice recognition. In one aspect, digital video recorder (DVR) functionality may include the ability to select and play back particular television programming stored in the memory 102 on a display device such as the digital television 300 based on instructions obtained through voice recognition. In one aspect, this functionality may be provided through a paid service implemented by the wireless broadband television broadcast support platform 260. In one aspect, the DVR functionality may interact with Television-based IPGs in conjunction with Program Delivery Control (PDC) technology that may also facilitate a selection of programs for recording with the digital video recorder (DVR) functionality. In this regard, the remote control 126 may interact with the set-top box 100 and/or the application 140 to provide input and control of the features described above.

In one aspect, the application 140 may be configured with the set-top box 100 and/or the wireless broadband television transceiver 120 to implement the application 140 and/or the application 140 may be configured to be responsive to a wireless broadband television broadcast support platform 260 to provide the digital video recorder (DVR) functionality to other devices. In this aspect, the digital video recorder (DVR) may include the ability to select and play back particular television programming stored in the memory 102 and transmit the television programming from the set-top box 100 via a wireless fidelity, other communication channel as defined herein, or the like. In one aspect, the set-top box 100 implementing the application 140 may operate as a digital media player. In this aspect, the set-top box 100 implementing the application 140 may enable users to play the television programming on another device. In this aspect, the set-top box 100 implementing the application 140 may enable users to play the television programming on another device by casting or telecasting wireless signals to the another device. In this regard, the remote control 126 may interact with the set-top box 100 and/or the application 140 to provide input and control of the features described above.

In one aspect, the application 140 may be configured with the set-top box 100 and/or the wireless broadband television transceiver 120 to implement the application 140 to provide and/or the application 140 may be configured to be responsive to a wireless broadband television broadcast support platform 260 to provide Subscription Based high definition Television Programming (for example, pay Per View, Netflix, Hulu, and others) to a set-top box 100 for viewing on a display device such as the digital television 300. In this regard, the set-top box 100 may operate as a digital media player configured to play video content from various content providers. In this regard, the remote control 126 may interact with the set-top box 100 and/or the application 140 to provide input and control of the features described above.

The set-top box 100 may be configured to display various information provided to the digital television 300 from the processor 114 of the set-top box 100, the computer readable medium 116, the application 140, and/or the like. The digital television 300 may include a screen. The screen may be a light-emitting diode display (LED), an electroluminescent display (ELD), a plasma display panel (PDP), a liquid crystal display (LCD), an organic light-emitting diode display (OLED), an active-matrix organic light-emitting diode (AMOLED) display, an IPS (In-plane switching) liquid crystal display (LCD), or any other display technology. In one aspect, the display may be configured to display television in response to the set-top box 100.

In one aspect, the displayed information may include video responsive to a television signal for displaying a television show and/or television content. In one aspect, the displayed information may include a graphical user interface related to the application 140 for providing DVR functionality, programming information, television guide information, channel access and display information, polices, subscription rules, and subscriber status, and the like.

In one aspect, the displayed information may include displaying icons, the network connection strength, the television signal strength, the type of mobile network data connection (such as 3G, 4G LTE, EVDO, Wi-Fi, etc.) the set-top box 100 is connected to, and/or other information potentially useful to the user. The information may be displayed simultaneously or the user may interact with an input device such as buttons on the set-top box 100 or on the remote control 126 to cycle through the various types of information for display.

The set-top box 100 may also have a power supply 124. The power supply 124 may connect to and may be operative to nominal AC voltage. The power supply 124 may also include a battery such as nickel cadmium, nickel metal hydride, lead acid, lithium ion, lithium ion polymer, and the like. The set-top box 100 may also include a memory 102, which could be an internal memory, such as a hard drive, and/or a removable storage type, such as a memory chip. The memory 102 may store information about the set-top box 100, including wireless profiles and settings. Additionally, the set-top box 100 may include an audio input/output device 122 for the input or output of sounds in videos, music, television, and the like. The set-top box 100 may use the remote control 126 to facilitate use of the set-top box 100 with an operating system 136, the application 140, and the like.

The SIM 112 may be implemented as a subscriber identity module (SIM) card. In other aspects, the set-top box 100 may be implemented without a SIM 112. The SIM 112 may vary in size and may be a micro, mini, nano size, or any size implementation of the SIM 112. The SIM 112 may be associated with a client, which may manage the SIM 112 to control which wireless networks the set-top box 100 may connect. The SIM 112 may store network-specific information used to authenticate and identify subscribers on the network including one or more of an integrated circuit card identifier (ICCID), International Mobile Subscriber Identity (IMSI), Authentication Key (Ki), Local Area Identity (LAI), Operator-Specific Emergency Number, and/or the like. The SIM 112 may also store other carrier-specific data such as the SMSC (Short Message Service Center) number, Service Provider Name (SPN), Service Dialing Numbers (SDN), Advice-Of-Charge parameters, Value Added Service (VAS) applications, and/or the like. The SIM 112 may be identified by its ICCID. ICCIDs may be stored in the SIM cards. The ICCID is defined by the ITU-T recommendation E.118 as the Primary Account Number. The SIM 112 layout may be based on ISO/IEC 7812. In some aspects, the SIM 112 may also be a soft SIM, electronic SIM, or embedded SIM. In some aspects, other memory locations of the set-top box 100 may store carrier-specific data such as the International Mobile Subscriber Identity (IMSI), Authentication Key (Ki), Local Area Identity (LAI), Operator-Specific Emergency Number, the SMSC (Short Message Service Center) number, Service Provider Name (SPN), Service Dialing Numbers (SDN), Advice-Of-Charge parameters, Value Added Service (VAS) applications, and/or the like.

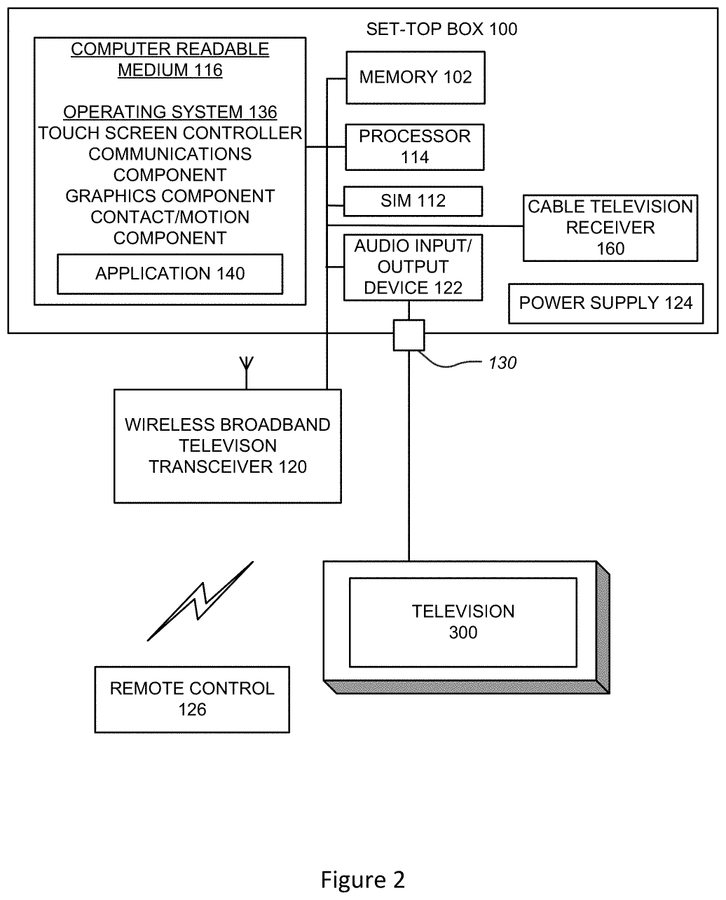

FIG. 2 illustrates another exemplary set-top box and a separate wireless broadband television transceiver in accordance with aspects of the disclosure.

In particular, FIG. 2 illustrates an aspect where the wireless broadband television transceiver 120 may be implemented as a separate device. In one aspect, the wireless broadband television transceiver 120 may wirelessly connect to the set-top box 100 over a communication channel as defined herein. In one aspect, the wireless broadband television transceiver 120 may be physically connected to the set-top box 100. In one aspect, the physical connection to the set-top box 100 may utilize USB (Universal Serial Bus) connection. In this aspect, the USB connection may utilize USB specifications for cables, connectors and protocols for connection, communication, and power supply between the set-top box 100 and the wireless broadband television transceiver 120. In this aspect, the USB specifications may include one or more USB 1.x, USB 2.0, USB 3.x, and the like. In one aspect, the physical connection to the set-top box 100 may utilize a Lightning computer bus and power connector. In this aspect, Lightning specifications for cables, connectors and protocols for connection, communication, and power supply may be utilized between the set-top box 100 and the wireless broadband television transceiver 120.

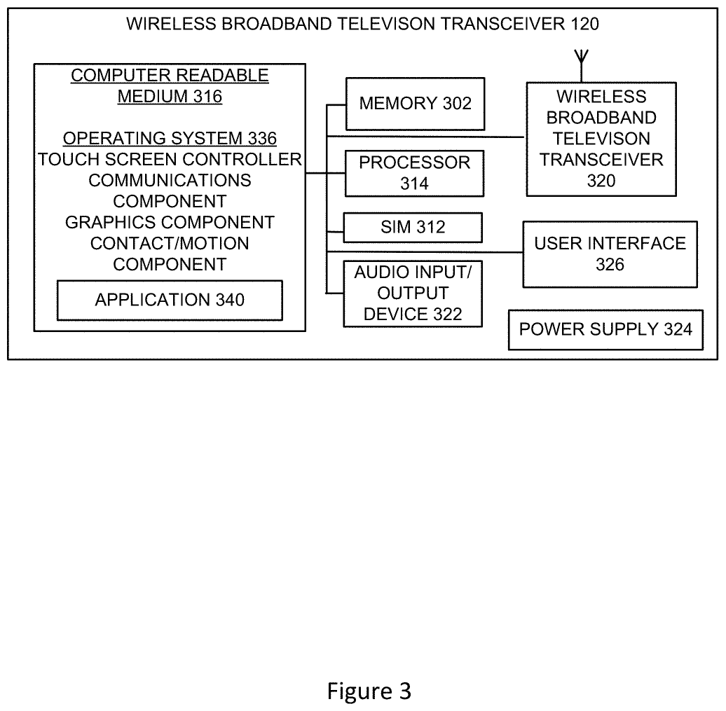

FIG. 3 illustrates a wireless broadband television receiver in accordance with aspects of the disclosure.

In particular, FIG. 3 illustrates an exemplary implementation of the wireless broadband television transceiver 120. In this regard, the wireless broadband television transceiver 120 may include one or more of a transceiver 320, a display, a computer readable medium 316, a processor 314, an application 340, a power supply 324, a location determination device, a user interface 326, a memory 302, an audio input/output device 322, an operating system 336, a SIM 312, and the like. However, the wireless broadband television transceiver 120 may be implemented with a greater number of components or a fewer number of components depending on the desired implementation. In one aspect, the features of the wireless broadband television transceiver 120 may be utilized in the FIG. 1 aspect and/or the FIG. 2 aspect. In one aspect, the features of the wireless broadband television transceiver 120 may utilize any other components, features, or the like set forth in the disclosure. The transceiver 320, the display, the computer readable medium 316, the processor 314, the application 340, the power supply 324, the user interface 326, the memory 302, the audio input/output device 322, the operating system 336 may be implemented consistent with similar components described herein.

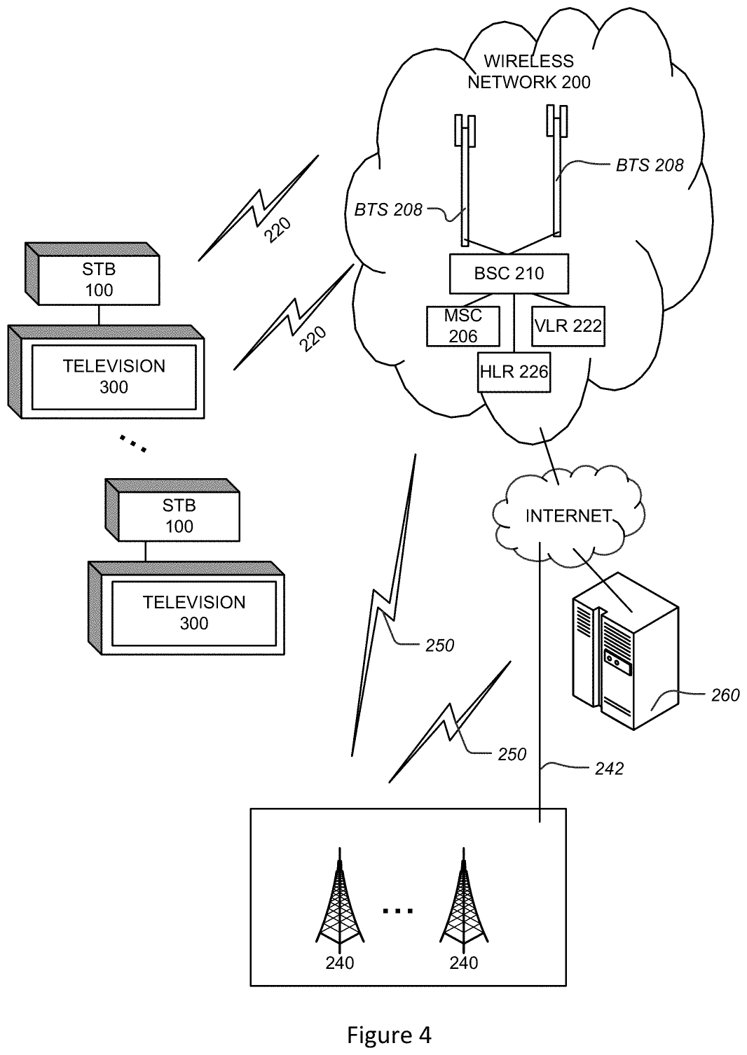

FIG. 4 illustrates an exemplary television broadcast network and wireless network as well as set-top boxes in accordance with aspects of the disclosure.

In particular, FIG. 4 illustrates a plurality of television stations 240, a wireless network 200, a wireless broadband television broadcast support platform 260, and a plurality of the set-top box 100.

In one aspect, the television stations 240 may utilize Digital Terrestrial Television. In one aspect, the Digital Terrestrial Television may utilize a technology for broadcast television in which land-based (terrestrial) television stations broadcast television content by radio waves to televisions. In one aspect, the television stations 240 may utilize Advanced Television Systems Committee (ATSC) standards. In some aspects, the ATSC may include two primary high definition video formats, 1080i and 720p. In some aspects, the ATSC may also include standard-definition formats. In some aspects, the ATSC may support 5.1-channel surround sound using Dolby Digital's AC-3 format. In some aspects, the ATSC may include Moving Picture Experts Group (MPEG) video coding, AC-3 audio coding, 8VSB modulation, and the like.

As illustrated in FIG. 4, the wireless network 200 and/or the wireless broadband television broadcast support platform 260 may receive the Digital Terrestrial Television by radio waves 250 in a digital format. In one aspect, the wireless network 200 and/or the wireless broadband television broadcast support platform 260 may receive the Digital Terrestrial Television by radio waves 250 and/or the wireless broadband television broadcast support platform 260 in a digital format utilizing ATSC 3.0. Additionally or alternatively, the wireless network 200 and/or the wireless broadband television broadcast support platform 260 may receive the Digital Terrestrial Television over the Internet in a digital format utilizing an Internet transmission 242. In one aspect, the wireless network 200 and/or the wireless broadband television broadcast support platform 260 may receive the Digital Terrestrial Television over the Internet utilizing an Internet transmission 242 in a digital format utilizing ATSC 3.0. As further illustrated in FIG. 4, the wireless broadband television broadcast support platform 260 may transmit the Digital Terrestrial Television on a communication channel to the wireless network 200. As further illustrated in FIG. 4, the wireless network 200 may transmit the Digital Terrestrial Television on a communication channel 220 to the set-top box 100.

Other digital television broadcast standards may be utilized including DVB standards, DVB-T, DVB-T2, DVB-S, DVB-S2, DVB-S2X, DVB-C, DVB-C2, DVB-H, DVB-NGH, DVB-T2-Lite, DVB-SH, ATSC 2.0, ATSC-M/H, ISDB, ISDB-T, ISDB-T, SBTVD, ISDB-S, ISDB-C, 1seg, DTMB, DTMB, DTMB-A, CMMB, DMB standard, T-DMB, S-DMB, and the like. The digital television broadcast may utilize various Codecs including H.265/MPEG-H HEVC, H.264/MPEG-4 AVC, H.262/MPEG-2 Part 2, VC-1, AVS, MPEG-H, HE-AAC, AAC, AC-4, E-AC-3, AC-3, MP3, MP2, the like. The digital television broadcast may utilize various frequency bands including VHF (Very High Frequency), UHF (Ultra High Frequency), SHF (Super High Frequency), and the like.

FIG. 4 further illustrates the wireless broadband television broadcast support platform 260. In one aspect, the wireless broadband television broadcast support platform 260 may be implemented as a computer system. In one aspect, the wireless broadband television broadcast support platform 260 may be implemented as a server computer system.

Additionally, FIG. 4 shows a wireless network 200 that may include a Mobile services Switching Center (MSC) 206 that may perform the switching of calls and that may include a Visitor Location Register (VLR) 222. The wireless network 200 may also include a Base Transceiver Station (BTS) 208 and a Base Station Controller (BSC) 210. The Base Transceiver Station (BTS) 208 houses the radio transceivers that define a cell and handle the radio-link protocols with the set-top box 100. The Base Station Controller (BSC) 210 may manage the radio resources for one or more Base Transceiver Station (BTS) 208. The Base Station Controller (BSC) 210 may be the connection between the set-top box 100 and the Mobile service Switching Center (MSC) 206.

A Home Location Register (HLR) 226 and the Visitor Location Register (VLR) 222 together with the Mobile services Switching Center (MSC) 206 may provide the call-routing and roaming capabilities. The Home Location Register (HLR) 226 may contain all the administrative information of each subscriber registered in the wireless network 200, along with the current location of the set-top box 100.

The wireless network 200 may include a home subscriber server (HSS), a user profile server function (UPSF), and/or the like. The HSS may be a master user database that supports IP Multimedia Core Network Subsystem (IMS) network entities. It may contain the subscription-related information (subscriber profiles), perform authentication and authorization of the user, and can provide information about the subscriber's location and IP information.

The wireless network 200 may further include a switch. The switch may be implemented by one or more of the Mobile services Switching Center (MSC) 206, the Home Location Register (HLR) 226, the Visitor Location Register (VLR) 222, the Base Transceiver Station (BTS) 208, the Base Station Controller (BSC) 210, the home subscriber server (HSS), a separate component, and/or the like.

The wireless network 200 may include a radio access network (RAN). The radio access network (RAN) may be implemented as part of a mobile telecommunication system of the wireless network 200. The radio access network (RAN) may implement a radio access technology. The radio access network (RAN) may reside between the set-top box 100 and the wireless network 200 and may provide a connection with a core network (CN).

In one aspect, the wireless network 200 may connect to the set-top box 100 over communication channels 220 as defined herein. The wireless network 200 may connect the set-top box 100 to the wireless broadband television broadcast support platform 260. In this regard, the set-top box 100, the application 140, and the wireless broadband television broadcast support platform 260 may exchange data including data regarding DVR functionality, programming information, television guide information, channel access and display information, polices, subscription rules, and subscriber status, and the like.

In further aspects, the set-top box 100 may connect to a wireless fidelity network that provides access to the Internet. The wireless fidelity network may connect the set-top box 100 to the wireless broadband television broadcast support platform 260. In this regard, the set-top box 100, the application 140 and the wireless broadband television broadcast support platform 260 may exchange data including data regarding data relating to DVR functionality, programming information, television guide information, channel access and display information, polices, subscription rules, and subscriber status, and the like.

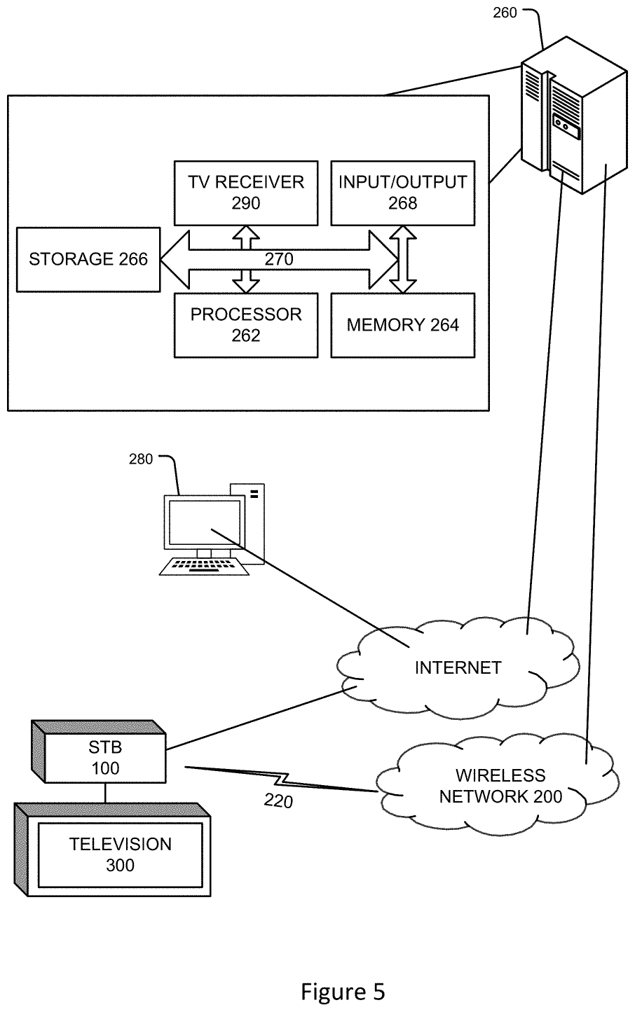

FIG. 5 illustrates a wireless broadband television broadcast support platform in accordance with aspects of the disclosure.

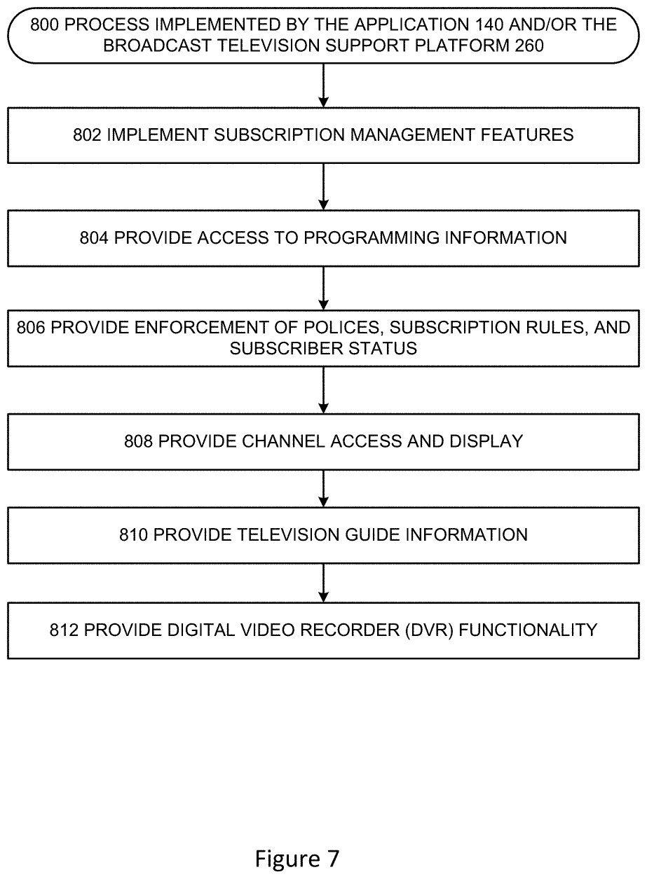

FIG. 5 shows a schematic diagram of an exemplary implementation of the wireless broadband television broadcast support platform 260 or platform that can be used to implement wireless broadband television services for the set-top box 100 and/or the wireless broadband television transceiver 120. In particular, the wireless broadband television broadcast support platform 260 may operate to provide some or all of the wireless broadband television services and/or the wireless broadband television service functionality as described herein including, for example, DVR functionality, programming information, television guide information, channel access and display information, polices, subscription rules, and subscriber status, and the like. The wireless broadband television broadcast support platform 260 may include a processor 262, a memory 264, a storage device 266, a television receiver 290, and an input/output device 268. Each of the processor 262, the memory 264, the storage device 266, and the input/output device 268 can, for example, be interconnected using a system bus 270. The processor 262 may be capable of processing instructions for execution within the wireless broadband television broadcast support platform 260. In one implementation, the processor 262 is a single-threaded processor. In another implementation, the processor 262 is a multi-threaded processor. The processor 262 may be configured for processing instructions stored in the memory 264 or on the storage device 266 to provide communications to the set-top box 100. The processor 262 may be configured for processing instructions stored in the memory 264 or on the storage device 266 that include a process 800 described below and illustrated in FIG. 7. In some aspects, a parallel processing set of the wireless broadband television broadcast support platform 260 may be connected over a network may be employed, clustered into one or more server centers.

In one aspect, the television receiver 290 may implement ATSC 3.0 (Advanced Television Systems Committee) standards. In one aspect, the television receiver 290 may be configured to support technologies, including High Efficiency Video Coding (HEVC) for video channels of up to 2160p 4K resolution (horizontal display resolution of approximately 4,000 pixels) at 120 frames per second, wide color gamut, high dynamic range, Dolby AC-4 and MPEG-H 3D (Moving Picture Experts Group) Audio, datacasting capabilities, and robust mobile television support. In further aspects, the television receiver 290 may utilize different video coding with a different resolution. In further aspects, the television receiver 290 may utilize different video coding with a higher resolution.

In one aspect, the television receiver 290 may implement a Software-Defined Radio (SDR) chip. In one aspect, the SDR chip implementation of the television receiver 290 may provide a re-usable and “future-proof” radio platform by combining an RF-to-baseband transceiver PHY (physical layer), a digital processor, and the like. In one aspect, the SDR chip implementation of the television receiver 290 may include software-configurability and control, improved system performance, reduction in system size, and the like.

In one aspect, the television receiver 290 may implement an SDR chip that may include a plurality separate inputs that may be provided each with a dedicated low noise amplifier. In one aspect, the television receiver 290 may precondition the radio frequency signal for each port and may be amplified by a programmable low-noise amplifier. In one aspect, the television receiver 290 may operate with the radio frequency signal to mix the radio frequency with a phase locked loop output to directly down convert to a baseband. In one aspect, the television receiver 290 may implement an intermediate frequency amplifier, a programmable bandwidth low-pass channel select filter, a programmable gain amplifier, at least one analog-to-digital converter, a baseband processor, and the like.

In one aspect, the television receiver 290 may implement a demodulator package, a demodulator with analog/digital conversion capability, and a demodulator with analog/digital conversion plus an embedded turner. In one aspect, the television receiver 290 may utilize a closely coupled antenna array to ensure reception in a high-speed mobile environment. In one aspect, the television receiver 290 may implement mobile smart television capabilities that may provide access to paid and or premium content delivered via television broadcast to the set-top box 100.

In one aspect, the television receiver 290 may implement other digital television broadcast standards including DVB standards, DVB-T, DVB-T2, DVB-S, DVB-S2, DVB-S2X, DVB-C, DVB-C2, DVB-H, DVB-NGH, DVB-T2-Lite, DVB-SH, ATSC 2.0, ATSC-M/H, ISDB, ISDB-T, ISDB-T, SBTVD, ISDB-S, ISDB-C, 1seg, DTMB, DTMB, DTMB-A, CMMB, DMB standard, T-DMB, S-DMB, and the like. In one aspect, the television receiver 290 may utilize various Codecs including H.265/MPEG-H HEVC, H.264/MPEG-4 AVC, H.262/MPEG-2 Part 2, VC-1, AVS, MPEG-H, HE-AAC, AAC, AC-4, E-AC-3, AC-3, MP3, MP2, the like. In one aspect, the television receiver 290 may be implemented to receive various frequency bands including VHF (Very High Frequency), UHF (Ultra High Frequency), SHF (Super High Frequency), and the like.

The memory 264 may store information within the wireless broadband television broadcast support platform 260. In one implementation, the memory 264 is a computer-readable medium. In one implementation, the memory 264 is a volatile memory unit. In another implementation, the memory 264 is a non-volatile memory unit. The storage device 266 may be configured for providing mass storage for the wireless broadband television broadcast support platform 260. In one implementation, the storage device 266 is a computer-readable medium. In various different implementations, the storage device 266 can, for example, include a hard disk device, an optical disk device, or some other large capacity storage device. In one aspect, the storage device 266 may store information and data regarding the set-top box 100 as well as data, information, and for implementing software DVR functionality, programming information, television guide information, channel access and display information, polices, subscription rules, and subscriber status, and the like.

The input/output device 268 may provide input/output operations for the wireless broadband television broadcast support platform 260. In one aspect, the input/output device 268 may include a transceiver configured to connect the wireless broadband television broadcast support platform 260 to the set-top box 100 over a network such as the wireless network 200, the Internet, and/or the like. In one aspect, input/output device 268 may provide input/output operations for the wireless broadband television broadcast support platform 260 including information, data, and software with respect to the DVR functionality, programming information, television guide information, channel access and display information, polices, subscription rules, and subscriber status, and the like. In one aspect, the wireless broadband television broadcast support platform 260 may be configured to connect to a computer 280 directly or over the Internet. In one aspect, the computer 280 may provide administrative input and control to the wireless broadband television broadcast support platform 260.

In one aspect, the processor 262 may include an Application Programming Interface (API). More specifically, the processor 262 may include one or more Application Programming Interfaces (API) such that the processor 262 provides wireless broadband television services to the set-top box 100 and/or the wireless broadband television transceiver 120 that may include one or more of the DVR functionality, programming information, television guide information, channel access and display information, polices, subscription rules, and subscriber status, and the like.

The processor 262 may further utilize artificial intelligence as well. In some aspects, the processor 262 may utilize artificial intelligence to control and/or provide the DVR functionality, programming information, television guide information, channel access and display information, polices, subscription rules, and subscriber status, and the like.

The artificial intelligence as described herein may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

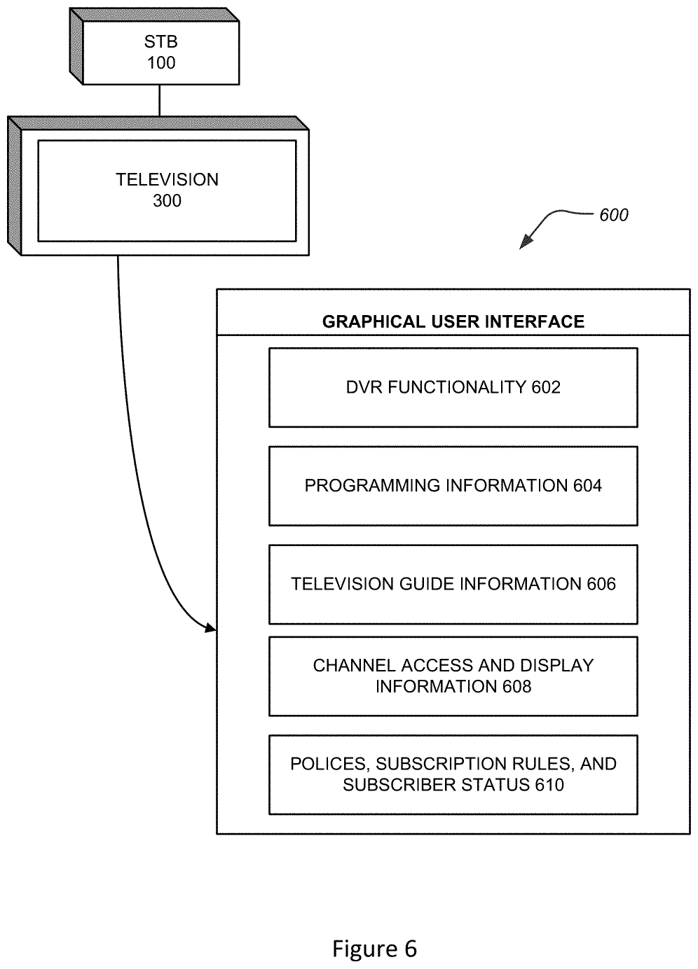

FIG. 6 illustrates a graphical user interface for a set-top box in accordance with aspects of the disclosure.

In particular, FIG. 6 illustrates a graphical user interface 600 that may be generated by the application 140. The graphical user interface 600 may be responsive to inputs from the remote control 126 that may include inputs to launch additional functionality. The inputs may include a DVR functionality input 602, a programming information input 604, a television guide information input 606, a channel access and display information input 608, a polices, subscription rules, and subscriber status input 610. In one aspect, a user selecting one of the inputs, with for example the remote control, may launch a separate graphical user interface dedicated to the input that provides information, allows selection, allows modification, and the like associated with the input. However, the graphical user interface 600 may be implemented with a greater number of inputs or a fewer number of inputs depending on the desired implementation and the desired features consistent with the disclosure.

FIG. 7 illustrates a process of implementing a wireless broadband television broadcast support platform and/or an application responsive to a wireless broadband television broadcast support platform in accordance with aspects of the disclosure.

In particular, FIG. 7 illustrates a process 800 that may be implemented by the application 140 and/or the wireless broadband television broadcast support platform 260 such that the set-top box 100 and/or the wireless broadband television transceiver 120 may implement various features.

In one aspect, the process 800 may implement subscription management features 802. In particular, the subscription management features 802 may allow a user of the set-top box 100 to control subscription management features as described herein. In one aspect, the wireless broadband television services as described by this disclosure may include subscription to various information, features, data, and the like provided by the application 140 and/or the wireless broadband television broadcast support platform 260. In one aspect, the process 800 may be configured to add, modify, or the like subscription to the various information, features, data, and the like provided by the application 140 and/or the wireless broadband television broadcast support platform 260. In one aspect, the application 140 may be configured to generate a graphical user interface to display controls to view, utilize, implement, add, delete, modify, and/or the like subscription to the various information, features, data, and the like provided by the application 140 and/or the wireless broadband television broadcast support platform 260. In this regard, the remote control 126 may interact with the set-top box 100 and/or the application 140 to provide input and control of the features described above.

In one aspect, the process 800 may implement access to programming information 804. In particular, the programming information 804 may allow a user of the set-top box to access programming information as described herein. In one aspect, the application 140 may be configured to view, utilize, implement, add, delete, modify, and/or the like programming information provided by the application 140 and/or the wireless broadband television broadcast support platform 260. In one aspect, the application 140 may be configured to generate a graphical user interface to display controls to view, utilize, implement, add, delete, modify, and/or the like the programming information provided by the application 140 and/or the wireless broadband television broadcast support platform 260. In one aspect, the programming information may include Electronic program guides (EPGs) and/or interactive program guides (IPGs) that may be menu-based systems that provide users of the application 140 with continuously updated menus displaying broadcast programming (TV listings) or scheduling information for current and upcoming programming. In this regard, the remote control 126 may interact with the set-top box 100 and/or the application 140 to provide input and control of the features described above.

In one aspect, the process 800 may provide access and/or provide enforcement of polices, subscription rules, and subscriber status 806 as described herein. In one aspect, the policies may be enforced by the application 140 that are provided by the wireless broadband television broadcast support platform 260. In one aspect, the wireless broadband television broadcast support platform 260 may be configured to view, utilize, implement, add, delete, modify, and/or the like policies based upon subscription rules and subscriber status.

In one aspect, the process 800 may provide access and/or provide channel access and display 808 as described herein. In one aspect, the application 140 may be configured to view, utilize, implement, add, delete, modify, and/or the like channel access provided by the application 140 and/or the wireless broadband television broadcast support platform 260. In one aspect, the application 140 may be configured to generate a graphical user interface to display television programming provided by the application 140 and/or the wireless broadband television broadcast support platform 260. In one aspect, the application 140 may be configured to generate a graphical user interface to display television programming provided by the application 140 and/or the wireless broadband television broadcast support platform 260 based on location of the set-top box 100. In this regard, the remote control 126 may interact with the set-top box 100 and/or the application 140 to provide input and control of the features described above.

In one aspect, the process 800 may provide access and/or provide television guide information 810 as described herein. In one aspect, the television guide information may be provided by paid subscription. The television guide information may include channels, television shows, sporting events, times, length of shows, cast, production crew and personnel biographies, plot summaries, trivia, and fan reviews and ratings, and the like. In one aspect, the application 140 may include a graphical user interface to search the television guide to find television content. In this regard, the remote control 126 may interact with the set-top box 100 and/or the application 140 to provide input and control of the features described above.

In one aspect, the process 800 may provide access and/or provide digital video recorder (DVR) functionality 812 as described herein. In one aspect, digital video recorder (DVR) functionality may include the ability to record, pause, fast-forward, rewind, and the like the received television signals. In one aspect, digital video recorder (DVR) functionality may include the ability to select and play back the particular television programming stored in the memory 102. In one aspect, digital video recorder (DVR) functionality may include the ability to delete the particular television programming stored in the memory 102.

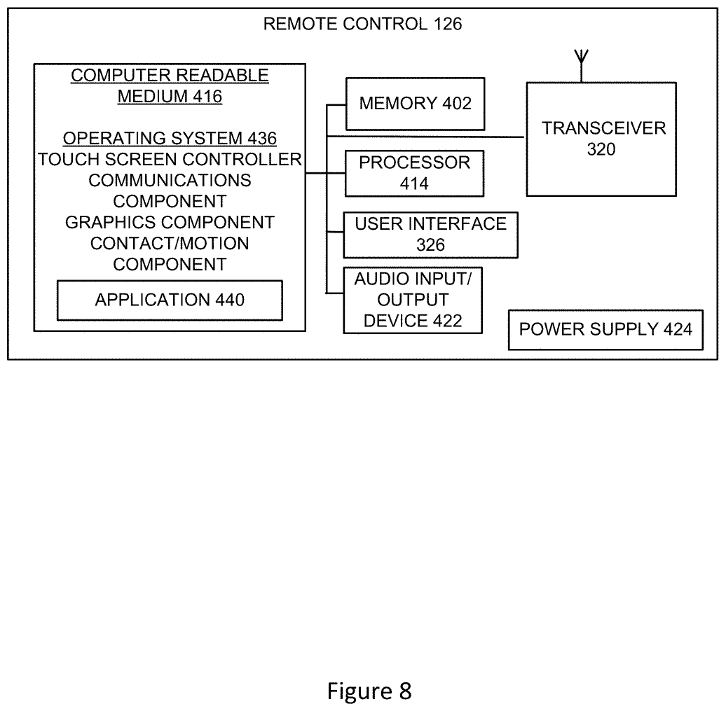

FIG. 8 illustrates a remote control in accordance with aspects of the disclosure.

In particular, FIG. 8 illustrates an exemplary implementation of the remote control 126. In this regard, the remote control 126 may include one or more of a transceiver 420, a display, a computer readable medium 416, a processor 414, an application 440, a power supply 424, a user interface 426, a memory 402, an audio input/output device 422, an operating system 436, and the like. However, the remote control 126 may be implemented with a greater number of components or a fewer number of components depending on the desired implementation. In one aspect, the remote control 126 may utilize voice recognition technology as described herein in conjunction with the audio input/output device 422, the processor 414, the application 440, and/or the like. The transceiver 420, the display, the computer readable medium 416, the processor 414, the application 440, the power supply 424, the user interface 426, the memory 402, the audio input/output device 422, the operating system 436 may be implemented consistent with similar components described herein.

A large number of wireless service plans exist for customers desiring wireless services such as data, talk, and text messaging. To obtain these wireless services, customers generally have the option of entering into a post-paid service (e.g., contract for a period of time) or a pre-paid, contract-free service. The latter offers customers the freedom to initiate and stop wireless services without incurring expensive cancellation fees associated with a post-paid service. In this regard, the remote control 126 may interact with the set-top box 100 and/or the application 140 to provide input and control of the features described above.

Generally, companies that provide post-paid wireless services are wireless carriers or Mobile Network Operators (MNO) that maintain and control their own wireless networks. A MNO heavily relies on backend systems to address any provisional, billing, security, and data issues that might threaten the health of their networks. On the other hand, a Mobile Virtual Network Operator (MVNO) is a mobile operator that typically does not own its own frequency spectrum or have its own network infrastructure. MVNOs negotiate and enter into business agreements with third party wireless carriers or MNOs to purchase the right to use their networks for wireless services including volume of data, number of minutes of airtime/voice, and number of text messages used. In this regard, MVNOs may have a plurality of agreements with and the rights to use a plurality of MNO networks.

Convenience, timeliness, cost, service, and reliability of a set-top box and/or the wireless providers' systems are key factors that play into a user's experience. By developing a system to improve at least these factors, a more positive experience can be provided to the wireless user. The improved experience will help retain customer base and increase the number of customers willing to purchase wireless services. In order to do so, the following needs can be addressed by a platform for enabling and managing a mobile smart television, a process for enabling and managing a mobile smart television, and/or a mobile smart television that may be utilized by either MNOs or MVNOs. In one aspect, the wireless broadband television broadcast support platform 260 may be implemented in a MNO. In one aspect, the wireless broadband television broadcast support platform 260 may be implemented by a MNO. In one aspect, the wireless broadband television broadcast support platform 260 may be implemented in a MVNO. In one aspect, the wireless broadband television broadcast support platform 260 may be implemented by a MVNO.

As described herein, the disclosure has set forth a wireless broadband television transceiver 120 and a wireless broadband television broadcast support platform 260 that may be configured to provide free Local high definition Television Broadcasts and Programming to a set-top box 100. As described herein, the disclosure has also set forth a wireless broadband television transceiver 120 and a wireless broadband television broadcast support platform 260 that may be configured to provide paid Local high definition Television Broadcasts and Programming to a set-top box 100. As described herein, the disclosure has also set forth a wireless broadband television transceiver 120 and a wireless broadband television broadcast support platform 260 that may be configured to provide Sponsored high definition Television Broadcasts and Programming to a set-top box 100. As described herein, the disclosure has also set forth a wireless broadband television transceiver 120 and a wireless broadband television broadcast support platform 260 that may be configured to provide Subscription Based high definition Television Programming (for example, pay Per View, Netflix, Hulu, and others) to a set-top box 100.

Further in accordance with various aspects of the disclosure, the methods described herein are intended for operation with dedicated hardware implementations including, but not limited to processors, microprocessors, set-top box chipsets, PCs, PDAs, SIM cards, semiconductors, application specific integrated circuits (ASIC), programmable logic arrays, cloud computing devices, and other hardware devices constructed to implement the methods described herein.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The wireless networks 200 may include a Mobility Management Entity (MME). The MME may function as a key control-node. The MME may be responsible for idle mode of the set-top box 100 as well as paging and tagging procedures including retransmissions. The MME may be involved in the bearer activation/deactivation process and may also responsible for choosing a Signaling Gateway (SGW) for the set-top box 100 at the initial attach and at a time of intra-LTE handover involving Core Network (CN) node relocation. The MME may be responsible for authenticating the set-top box 100 by interacting with a home subscriber server (HSS). Non Access Stratum (NAS) signaling may terminate at the MME and may also be responsible for generation and allocation of temporary identities to the set-top box 100. The MME may check the authorization of the set-top box 100 to camp on the service provider's Public Land Mobile Network (PLMN) and may enforce roaming restrictions on the set-top box 100. The MME may be a termination point in the wireless network 200 for ciphering/integrity protection for NAS signaling and may handle the security key management. The MME may also provide a control plane function for mobility between LTE and 2G/3G access networks with an S3 interface terminating at the MME from the Serving GPRS Support Node (SGSN). The MME may also terminate an S6a interface towards the home HSS for a roaming set-top box 100.

The SGW may be implemented as a network component responsible for transferring signaling messages (i.e. information related to call establishment, billing, location, short messages, address conversion, and other services) between Common Channel Signaling (CCS) nodes that communicate using different protocols and transports.

In one aspect, the wireless network 200 may include a public data network (PDN) gateway (PDN GW). The PDN GW may contain devices such as protocol translators, impedance matching devices, rate converters, fault isolators, or signal translators as necessary to provide system interoperability. The PDN GW may also require the establishment of mutually acceptable administrative procedures between networks.

The PDN may be a circuit-switched or packet-switched network that can transmit data in digital form. The PDN may provide any of X.25, frame relay, cell relay (ATM), or the like services. Access to a PDN generally includes a guaranteed bandwidth, known as the committed information rate (CIR).

In one aspect, the wireless network 200 may include an S5/S8 interface that may be used within the Evolved Packet Core (EPC) for LTE. The S5 interface may provide user plane tunneling and tunnel management between a serving GW and PDN GW. It may be used for Serving GW relocation due to the set-top box 100 mobility and if the serving GW needs to connect to a non-collocated PDN GW for the required PDN connectivity.

According to an example, the location determination devices may be responsive to a global navigation satellite system (GNSS) and may include a device and/or system that may estimate its location based, at least in part, on signals received from space vehicles (SVs) for the set-top box 100. In particular, such a device and/or system may obtain “pseudorange” measurements including approximations of distances between associated SVs and a navigation satellite receiver. In a particular example, such a pseudorange may be determined at a receiver that is capable of processing signals from one or more SVs as part of a Satellite Positioning System (SPS). Such an SPS may include, for example, a Global Positioning System (GPS), Galileo, Glonass, to name a few, or any SPS developed in the future. To determine its location, a satellite navigation receiver may obtain pseudorange measurements to three or more satellites as well as their positions at time of transmitting. Knowing the SV orbital parameters, these positions can be calculated for any point in time. A pseudorange measurement may then be determined based, at least in part, on the time a signal travels from an SV to the receiver, multiplied by the speed of light. While techniques described herein may be provided as implementations of location determination in GPS and/or Galileo types of SPS as specific illustrations according to particular examples, it should be understood that these techniques may also apply to other types of SPS, and that claimed subject matter is not limited in this respect.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The disclosure may include communication channels 220 that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, Long Term Evolution (LTE), EVolution-Data Optimized (EVDO), 4G, 5G, and/or the like, and/or a combination of two or more thereof.

The application 140 described in the disclosure may be implemented to execute on an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like. The application may be displayed as an icon. The application may have been downloaded from the Internet, pre-installed, or the like. In some aspects, the application may be obtained from Google Play™, Android Market™, Apple Store™, or the like digital distribution source. The application may be written in conjunction with the software developers kit (SDK) associated with an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system, or the like.

The disclosure may be implemented in any type of computing devices or processor, such as, e.g., a microprocessor, set-top box chipset, a desktop computer, personal computer, a laptop/mobile computer, a personal data assistant (PDA), a mobile phone, a tablet computer, cloud computing device, and the like, with wired/wireless communications capabilities via the communication channels 220.

In an aspect, the disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

The term data or data services as utilized herein includes mobile broadband or wireless Internet access delivered through mobile phone towers over a communication channel as defined herein to computers, mobile phones, set-top boxes, and other digital devices as defined herein using portable modems. Some mobile services allow more than one device to be connected to the Internet using a single cellular connection using a process called tethering.

Aspects of the disclosure may be web-based. For example, a server may operate a web application in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

Aspects of the disclosure include an Application Programming Interface (API). The API may include a set of subroutine definitions, protocols, and tools for building software. The set may include a set of defined methods of communication between the various components of the disclosure. The API may be implemented as a web-based system, an operating system, a database system, a computer hardware, a software library, or the like. The API may include an API specification that may include specifications for routines, data structures, object classes, variables, remote calls, and/or the like. The API may be associated with or related to a software library. The API may describe and prescribe the expected behavior as a set of rules and the software library may be an implementation of this set of rules. In one aspect, the API may be a remote API configured to manipulate remote resources through protocols, specific standards for communication, or the like that allow different technologies to work together, regardless of language or platform. In one aspect, the API may be POSIX, Windows API. In one aspect, the API may be ASPI. In one aspect, the API may be Java API. In one aspect, the API may be Java Database Connectivity API.

Voice recognition software may be utilized in various aspects of the systems and methods. Users may be able to vocalize, rather than utilizing other input processes. For example, the voice recognition software may be configured for generating text from voice input from a microphone or other voice input. A speech signal processor may convert speech signals into digital data that can be processed by the processor. The processor may perform several distinct functions, including serving as the speech event analyzer, the dictation event subsystem, the text event subsystem, and the executor of the application program. The speech signal processor may generate speech event data and transmit this data to the processor to be processed first by the speech event analyzer. The speech event analyzer may generate a list or set of possible candidates among the system recordings that represent or match the voice input processed by the speech signal processor. The speech event analyzer may transmit the candidate sets to a dictation event subsystem. The dictation event subsystem may analyze the candidate sets and choose the best match candidate with the highest degree of similarity. This candidate is then considered the correct translation, and the dictation event subsystem forwards the translation to the text event subsystem which in turn inputs the translated text into the device.

While the device, system, and method have been described in terms of what are presently considered to be specific aspects, the disclosure need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

1. A wireless broadband television system comprising:
a set-top box and the set-top box comprising:
a wireless broadband television transceiver configured to receive television services as broadband data from a wireless network;
a processor configured to control the wireless broadband television transceiver and execute an application;
the application configured to connect utilizing the wireless broadband television transceiver to the wireless network;
the application is further configured to implement and control the wireless broadband television transceiver;
an output configured to output audio and video associated with received television services; and
a computer readable medium configured to store the application.

2. The wireless broadband television system of claim 1 wherein:
the set-top box further comprises a cable television receiver configured to receive television services from one of a cable television network or a satellite television network;
the processor is further configured to control the cable television receiver; and
the application is further configured to implement and control the cable television receiver.

3. The wireless broadband television system of claim 1 wherein:
the set-top box is further configured to provide access to programming information of a television content; and
the programming information includes at least one of the following: electronic program guides (EPGs) and interactive program guides (IPGs) that include menu-based systems that provide users with continuously updated menus displaying broadcast programming.

4. The wireless broadband television system of claim 1 wherein:
the set-top box is further configured to provide digital video recorder (DVR) functionality; and
the digital video recorder (DVR) functionality includes play back, record, pause, fast-forward, and rewind functionality of television programming stored in a memory of the set-top box.

5. The wireless broadband television system of claim 1 wherein the application is further configured to connect utilizing the wireless broadband television transceiver to a wireless broadband television broadcast support platform via the wireless network.

6. The wireless broadband television system of claim 5 wherein the wireless broadband television broadcast support platform comprises:
at least one processor implementing the wireless broadband television broadcast support platform, the wireless broadband television broadcast support platform being configured to provide support to the set-top box implementing the wireless broadband television transceiver configured for receiving and outputting television content;
an input/output device, the input/output device configured to connect the wireless broadband television broadcast support platform over a wireless network to the set-top box implementing the wireless broadband television transceiver to support reception and output of the television content; and
the wireless broadband television broadcast support platform being configured to enforce polices based upon subscription rules and subscriber status on the set-top box implementing the wireless broadband television transceiver to support reception and output of the television content.

7. The wireless broadband television system of claim 5 wherein:
the wireless broadband television broadcast support platform being configured to implement subscription management features to the set-top box implementing the wireless broadband television transceiver to support reception and output of a television content; and
the subscription management features provided by the wireless broadband television broadcast support platform include at least one of the following: information provided by the wireless broadband television broadcast support platform, features provided by the wireless broadband television broadcast support platform, and data provided by the wireless broadband television broadcast support platform.

8. The wireless broadband television system of claim 5 wherein
the wireless broadband television broadcast support platform being configured to provide access to programming information to the set-top box implementing the wireless broadband television transceiver to support reception and output of a television content; and
the programming information includes at least one of the following: electronic program guides (EPGs) and interactive program guides (IPGs) that include menu-based systems that provide users with continuously updated menus displaying broadcast programming.

9. The wireless broadband television system of claim 5 wherein
the wireless broadband television broadcast support platform being configured to at least one of the following: add policies based upon subscription rules and subscriber status, delete policies based upon subscription rules and subscriber status, modify policies based upon subscription rules and subscriber status.

10. The wireless broadband television system of claim 5 wherein
the wireless broadband television broadcast support platform being configured to manage the wireless broadband television transceiver, channel access and display for the set-top box implementing the wireless broadband television transceiver to support reception and output of a television content.

11. The wireless broadband television system of claim 5 wherein
the wireless broadband television broadcast support platform being configured to provide television scheduling to the set-top box implementing the wireless broadband television transceiver to support reception and output of a television content; and
the television scheduling includes at least one of the following: channels, television shows, sporting events, times, length of shows, cast, production crew, personnel biographies, plot summaries, trivia, fan reviews, and ratings.

12. The wireless broadband television system of claim 5 wherein
the wireless broadband television broadcast support platform being configured to provide television guide information to the set-top box implementing the wireless broadband television transceiver to support reception and output of a television content.

13. The wireless broadband television system of claim 5 wherein
the wireless broadband television broadcast support platform being configured to provide digital video recorder (DVR) functionality to the set-top box implementing the wireless broadband television transceiver to support reception and output of a television content; and
wherein the digital video recorder (DVR) functionality includes play back, record, pause, fast-forward, and rewind functionality of television programming stored in a memory of the set-top box.

14. The wireless broadband television system of claim 5 wherein
the wireless broadband television broadcast support platform being configured to implement subscription management features to the set-top box implementing the wireless broadband television transceiver to support reception and output of a television content;
the wireless broadband television broadcast support platform being configured to provide access to programming information to the set-top box implementing the wireless broadband television transceiver to support reception and output of the television content;
the programming information includes at least one of the following: electronic program guides (EPGs) and interactive program guides (IPGs) that include menu-based systems that provide users with continuously updated menus displaying broadcast programming;
the wireless broadband television broadcast support platform being configured to at least one of the following: add policies based upon subscription rules and subscriber status, delete policies based upon subscription rules and subscriber status, modify policies based upon subscription rules and subscriber status;
the wireless broadband television broadcast support platform being configured to manage the wireless broadband television transceiver, channel access and display for the set-top box implementing the wireless broadband television transceiver to support reception and output of the television content;
the wireless broadband television broadcast support platform being configured to provide digital video recorder (DVR) functionality to the set-top box implementing the wireless broadband television transceiver to support reception and output of the television content; and
the digital video recorder (DVR) functionality includes play back, record, pause, fast-forward, and rewind functionality of television programming stored in a memory of the set-top box.

15. A wireless broadband television system process comprising:
providing a set-top box;
configuring the set-top box with a wireless broadband television transceiver to receive television services as broadband data from a wireless network;
configuring the set-top box with a processor to control the wireless broadband television transceiver and execute an application;
configuring the application to connect utilizing the wireless broadband television transceiver to the wireless network;
configuring the application to implement and control the wireless broadband television transceiver;
configuring the set-top box with an output to output audio and video associated with received television services; and
configuring the set-top box with a computer readable medium to store the application.

16. The wireless broadband television system process of claim 15 further comprising:
configuring the set-top box with a cable television receiver to receive television services from one of a cable television network or a satellite television network;
configuring the processor is further to control the cable television receiver; and
configuring the application is further to implement and control the cable television receiver.

17. The wireless broadband television system process of claim 15 further comprising:
configuring the set-top box to provide access to programming information of a television content,
wherein the programming information includes at least one of the following: electronic program guides (EPGs) and interactive program guides (IPGs) that include menu-based systems that provide users with continuously updated menus displaying broadcast programming.

18. The wireless broadband television system process of claim 15 further comprising configuring the set-top box with digital video recorder (DVR) functionality,
wherein the digital video recorder (DVR) functionality includes play back, record, pause, fast-forward, and rewind functionality of television programming stored in a memory of the set-top box.

19. The wireless broadband television system process of claim 15 further comprising configuring the application is further to connect utilizing the wireless broadband television transceiver to a wireless broadband television broadcast support platform via the wireless network.

20. The wireless broadband television system process of claim 19 further comprising:
configuring the wireless broadband television broadcast support platform to implement subscription management features to the set-top box implementing the wireless broadband television transceiver to support reception and output of a television content;
configuring the wireless broadband television broadcast support platform to provide access to programming information to the set-top box implementing the wireless broadband television transceiver to support reception and output of the television content;
configuring the programming information to include at least one of the following: electronic program guides (EPGs) and interactive program guides (IPGs) that include menu-based systems that provide users with continuously updated menus displaying broadcast programming;
configuring the wireless broadband television broadcast support platform to at least one of the following: add policies based upon subscription rules and subscriber status, delete policies based upon subscription rules and subscriber status, modify policies based upon subscription rules and subscriber status;
configuring the wireless broadband television broadcast support platform to manage the wireless broadband television transceiver, channel access and display for the set-top box implementing the wireless broadband television transceiver to support reception and output of the television content;
configuring the wireless broadband television broadcast support platform to provide digital video recorder (DVR) functionality to the set-top box implementing the wireless broadband television transceiver to support reception and output of the television content; and
configuring the digital video recorder (DVR) functionality to include play back, record, pause, fast-forward, and rewind functionality of television programming stored in a memory of the set-top box.
